(19) United States
(12) Patent Application Publication
(10) Pub. No.: US 2026/0242042 A1
(43) Pub. Date: Aug. 20, 2026

(54) METHOD AND APPARATUS FOR CONTROLLING SHIP PROPULSION, AND A PROPULSION SYSTEM

(71) Applicant: WÄRTSILÄ NETHERLANDS B.V., Drunen (NL)

(72) Inventor: Lauri TIAINEN, Drunen (NL)

(21) Appl. No.: 19/640,638

(22) Filed: Apr. 7, 2026

Related U.S. Application Data
(63) Continuation of application No. PCT/EP2023/080351, filed on Oct. 31, 2023.

(51) Int. Cl. B63H 3/10; B63H 21/14; B63H 21/20; B63H 25/06

(52) U.S. Cl. CPC B63H 3/10; B63H 21/14; B63H 21/20; B63H 25/06; B63H 2021/205; B63H 2025/066

(57) ABSTRACT

A propulsion system for moving a ship includes a controllable pitch propeller driven by an engine, a left rudder, a right rudder, and a control system, wherein the left rudder has a first turning axis and a first trailing edge, wherein the right rudder has a second turning axis and a second trailing edge, wherein a distance (w_{G}) between the trailing edges is adjustable by changing the difference (θ₁−θ₂) between a rudder angle (θ₁) of the left rudder and a rudder angle (θ₂) of the right rudder, wherein the propulsion system has first and second operating modes for changing the velocity of the ship.

### FIELD

The present invention relates to controlling ship propulsion.

### BACKGROUND

The velocity of a ship may need to be reduced e.g. when navigating in a narrow shipping lane. The velocity of the ship is typically reduced by reducing the power of the main engine of the ship.

### SUMMARY

An object is to provide a ship propulsion system. An object is to provide a ship, which comprises the propulsion system. An object is to provide a method for moving a ship. An object is to provide a method for controlling ship propulsion. An object is to provide an apparatus for controlling ship propulsion.

According to an aspect, there is provided a propulsion system (TWIN1) for moving a ship (SHIP1), the system (TWIN1) comprising:
a controllable pitch propeller (PRO1) driven by an engine (ENG1) and/or by an electric motor (MOT1),
a left rudder (R1),
a right rudder (R2), and
a control system (CSYS1),
   wherein the left rudder (R1) has a first turning axis (AX1) and a first trailing edge (TE1),
   wherein the right rudder (R2) has a second turning axis (AX2) and a second trailing edge (TE2),
   wherein a distance (w_{G}) between the trailing edges (TE1, TE2) is adjustable by changing the difference (θ₁−θ₂) between a rudder angle (θ₁) of the left rudder (R1) and a rudder angle (θ₂) of the right rudder (R2),
   wherein the propulsion system (TWIN1) has a first operating mode (MODE1), where changing the velocity (vₛ) of the ship (SHIP1) comprises changing the shaft power (Pₛ) of the propeller (PRO1),
   wherein the propulsion system (TWIN1) has a second operating mode (MODE2), where the control system (SYS1) is arranged to change the velocity (vₛ) of the ship (SHIP1) by changing the difference (θ₁−θ₂) between the rudder angle (θ₁) of the left rudder (R1) and the rudder angle (θ₂) of the right rudder (R2), wherein the control system (SYS1) is arranged to change the pitch angle (α_{P}) of the propeller (PRO1) such that the shaft power (Pₛ) is kept substantially equal to a first power value (P₁) in a situation where the velocity (vₛ) of the ship (SHIP1) is changed by changing the difference (θ₁−θ₂) between the rudder angles (θ₁,θ₂).

According to an aspect, there is provided the propulsion system of claim 1.

Further embodiments are defined in the other claims.

The scope of protection sought for various embodiments of the invention is set out by the independent claims. The embodiments, if any, described in this specification that do not fall under the scope of the independent claims are to be interpreted as examples useful for understanding various embodiments of the invention.

The propulsion system comprises a controllable pitch propeller, a left rudder and a right rudder. The ship may be turned by turning both rudders in the same direction, e.g. by turning left rudder clockwise, and by turning the right rudder clockwise. The velocity of the ship may be changed by turning the rudders in different directions. For example, the velocity of the ship may be reduced by turning the left rudder counterclockwise, and by turning the right rudder clockwise.

The thrust force generated by the propulsion system may depend on the width of the gap between the trailing edge of the left rudder and the trailing edge of the right rudder. A part of the water flow induced by the propeller passes through the gap. The velocity of the ship may be changed by changing the width of the gap. The width of the gap may be changed e.g. by turning the rudders in different directions. The two rudders may be arranged to operate together as an adjustable hydrodynamic brake. The rudders may be used as an adjustable gate, which may partly or completely block the slipstream of the propeller. The width of the gap may be called e.g. as the gate width. The braking effect may depend on the gate width. The braking effect may depend on the difference between the rudder angle of the left rudder and the rudder angle of the right rudder. The difference between the rudder angles may also be called e.g. as the braking angle.

The control system of the propulsion system may comprise an input device for controlling the braking effect of the rudders. The control system may comprise e.g. a brake control lever for controlling the braking effect of the rudders, by changing the width of the gap between the trailing edges of the rudders. The control system may be arranged to turn the rudders according user input received via the input device. The user may adjust the braking effect of the rudders by providing user input via the input device.

For moving at a normal cruising velocity straight ahead, both rudders may be e.g. substantially parallel with the direction of movement of the ship. For reducing the velocity of the ship, the rudders may be turned in different directions so that the gate width is reduced.

The present method utilizes a braking effect of the rudders. Decreasing the gate width may increase a braking force of the rudders. Decreasing the gate width may decrease the thrust force of the propulsion system in the forward direction.

Decreasing the gate width may even cause reversal of the direction of the thrust force, which is generated by the propulsion system. Using a very high braking angle may even reverse the direction of the thrust generated by the propulsion system, thereby causing stopping of the movement of the ship. The thrust reversal may even cause that the ship starts to move backwards (astern).

Increasing the gate width may decrease a braking force. Increasing the gate width may increase the thrust force of the propulsion system in the forward direction. The velocity of the ship may be increased by increasing the gate width.

A change of the gate width may also change the torque, which is needed to rotate the propeller. The effect of the change of the gate width may be compensated by adjusting the pitch angle of the propeller according to the rudder angles. The shaft power may be kept substantially constant by adjusting the pitch angle according to the rudder angles.

The output power of the engine needs to match the shaft power. Changing the output power of the ship engine may be a slow operation and/or may temporarily increase harmful emissions. Adjusting the pitch angle according to the rudder angles may improve operating reliability of the propulsion system, as the need for rapidly changing the shaft power and the output power may be avoided.

The pitch angle of the propeller, the ship velocity, the braking angle of the rudders, and the rotation speed of the propeller may have an effect on the propeller torque, i.e. on the torque which is needed to rotate the propeller. Reducing the gate width may increase the torque. Decreasing the pitch angle may decrease the torque. The control system may be arranged to reduce the pitch angle so as to compensate the increase of torque caused by the reduced gate width. The braking effect of the rudders may slow down the velocity of the ship, and reducing the ship velocity may increase the torque. The control system may be arranged to reduce the pitch angle so as to compensate an increase of torque caused by reduced velocity of the ship.

The rudder angles, the ship velocity, and the pitch angle of the propeller may have an effect on the shaft power. The method may comprise adjusting the pitch angle of the propeller such that the propeller torque is kept constant or substantially constant, in a situation where the ship velocity is changed by changing the difference between the rudder angles. The method may comprise changing the pitch angle of the propeller according to the rudder angles, so as to keep the torque substantially constant, in the situation where the ship velocity is changed by changing the difference between the rudder angles. The propeller may be arranged to provide a constant load. The propeller may be arranged to operate as a constant torque propeller.

The control unit of the propulsion system may be arranged to adjust the pitch angle of the propeller as a function of the rudder angles, such that the torque and/or power of the propeller is kept constant. Consequently, the ship may be maneuvered in port, or in a shipping lane, without a need to change the shaft power. The velocity of the ship may be reduced and/or increased by turning the rudders, without a need to change the shaft power, and without a need to change output power of the engine. There is no need to change the operating parameters of the engine during maneuvering operations. In particular, there is no need to change the output power of the engine during maneuvering. The twin rudder propulsion system may provide improved maneuverability.

The twin rudder propulsion system may reduce gaseous and/or particle emissions from the ship main engine, as the engine may be operated continuously in an optimum range of power.

The engine may be operated continuously in an optimum range of operating parameters, at a constant output power. There is no need to increase or decrease the amount of fuel, which is injected into each cylinder of the engine for each combustion stroke.

Changing the output power of the engine may be a slow operation, in particular when using a challenging fuel (e.g. ammonia). The present method allows changing the velocity without changing the output power of the engine. The twin rudder propulsion system may enable use of one or more challenging fuels. The twin rudder propulsion system may enable using e.g. ammonia as the fuel.

### BRIEF DESCRIPTION OF THE DRAWINGS

In the following examples, several variations will be described in more detail with reference to the appended drawings, in which

FIG. 1 shows, by way of example, in a side view, a ship, which comprises a twin rudder propulsion system,

FIG. 2 shows, by way of example, in a rear view, the ship of FIG. 1a

FIG. 3 shows, by way of example, in a three-dimensional view, a twin rudder propulsion system,

FIG. 4a shows, by way of example, in a top view, rudder angles in a situation where the difference between the rudder angles is 0° and the average of the rudder angles is 0°,

FIG. 4b shows, by way of example, in a top view, rudder angles in a situation where the difference between the rudder angles is 20° and the average of the rudder angles is 0°,

FIG. 4c shows, by way of example, in a top view, rudder angles in a situation where the difference between the rudder angles is 0° and the average of the rudder angles is −30°,

FIG. 4d shows, by way of example, in a top view, rudder angles in a situation where the difference between the rudder angles is 140° and the average of the rudder angles is 0°,

FIG. 5a shows, by way of example, in a top view, rudder angles in a situation where the difference between the rudder angles is 120° and the average of the rudder angles is 0°,

FIG. 5b shows, by way of example, in a top view, rudder angles in a situation where the difference between the rudder angles is 120° and the average of the rudder angles is −15°,

FIG. 5c shows, by way of example, in a top view, rudder angles in a situation where the difference between the rudder angles is 130° and the average of the rudder angles is-30°,

FIG. 5d shows, by way of example, in a top view, rudder angles in a situation where the difference between the rudder angles is 150° and the average of the rudder angles is 0°,

FIG. 6a shows, by way of example, states of input devices, and corresponding rudder angles, in a situation where the brake control value is 0% and a steering control angle is 0°,

FIG. 6b shows, by way of example, states of input devices, and corresponding rudder angles, in a situation where the brake control value is 30% and a steering control angle is 0°,

FIG. 6c shows, by way of example, states of input devices, and corresponding rudder angles, in a situation where the brake control value is 70% and a steering control angle is 0°,

FIG. 6d shows, by way of example, states of input devices, and corresponding rudder angles, in a situation where the brake control value is 70% and a steering control angle is −15°,

FIG. 7a shows, by way of example, an effect of the ship velocity on the propeller torque,

FIG. 7b shows, by way of example, an effect of the gate width on the propeller torque,

FIG. 7c shows, by way of example, an effect of the pitch angle on the propeller torque,

FIG. 7d shows, by way of example, a control system of the twin rudder propulsion system,

FIG. 8 shows, by way of example, in a top view, the velocity and the angular turning speed of the ship,

FIG. 9A shows, by way of example, a path of a ship in a shipping lane,

FIG. 9b shows, by way of example, temporal evolution of shaft power, temporal evolution of braking angle, temporal evolution of gate width, temporal evolution of ship velocity, and temporal evolution of pitch angle, as the ship moves along the path,

FIG. 10a shows, by way of example, a path of a ship, which approaches a berth,

FIG. 10b shows, by way of example, temporal evolution of shaft power, temporal evolution of braking angle, temporal evolution of gate width, temporal evolution of ship velocity, and temporal evolution of pitch angle, as the ship approaches the berth,

FIG. 11a shows, by way of example, a path of a ship, which leaves a berth,

FIG. 11b shows, by way of example, a ship turning in the vicinity of the berth,

FIG. 11c shows, by way of example, temporal evolution of shaft power, temporal evolution of braking angle, temporal evolution of gate width, temporal evolution of ship velocity, and temporal evolution of pitch angle, as the ship leaves the berth,

FIG. 12a shows, by way of example, method steps for changing the velocity of the ship,

FIG. 12b shows, by way of example, method steps for operating the propulsion system in the variable power operating mode and in the constant power operating mode,

FIG. 13a shows, by way of example, a propulsion system, which comprises a combination of an engine and a generator, and

FIG. 13b shows, by way of example, a propulsion system, which comprises a combination of an engine, a generator, and an electric motor.

### DETAILED DESCRIPTION

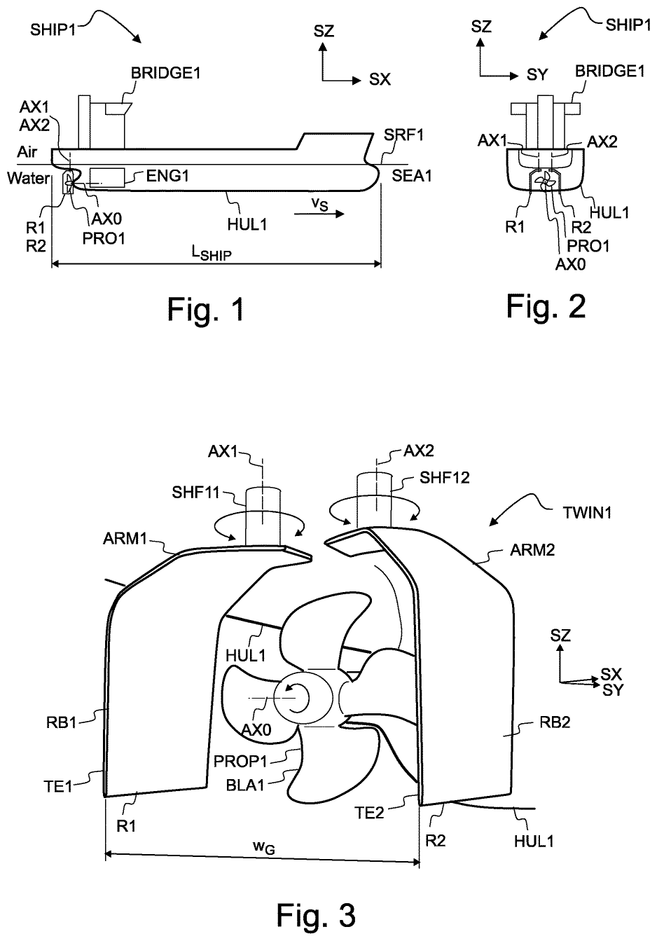

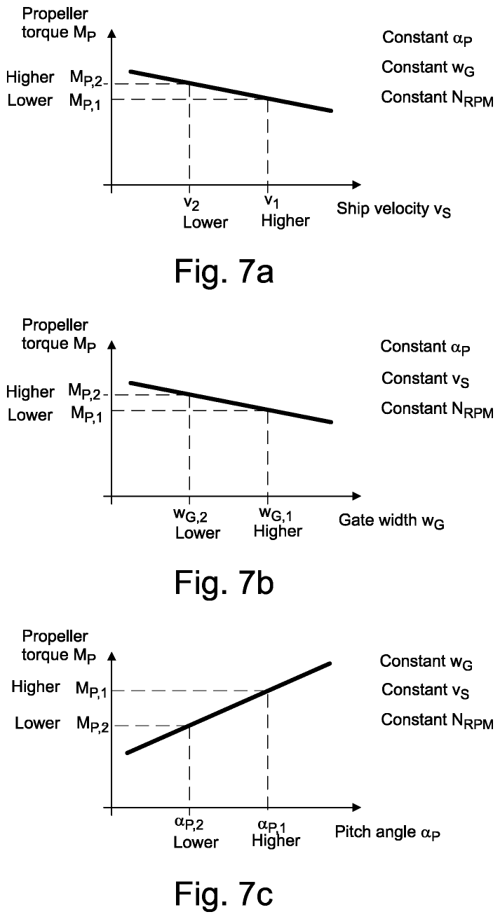

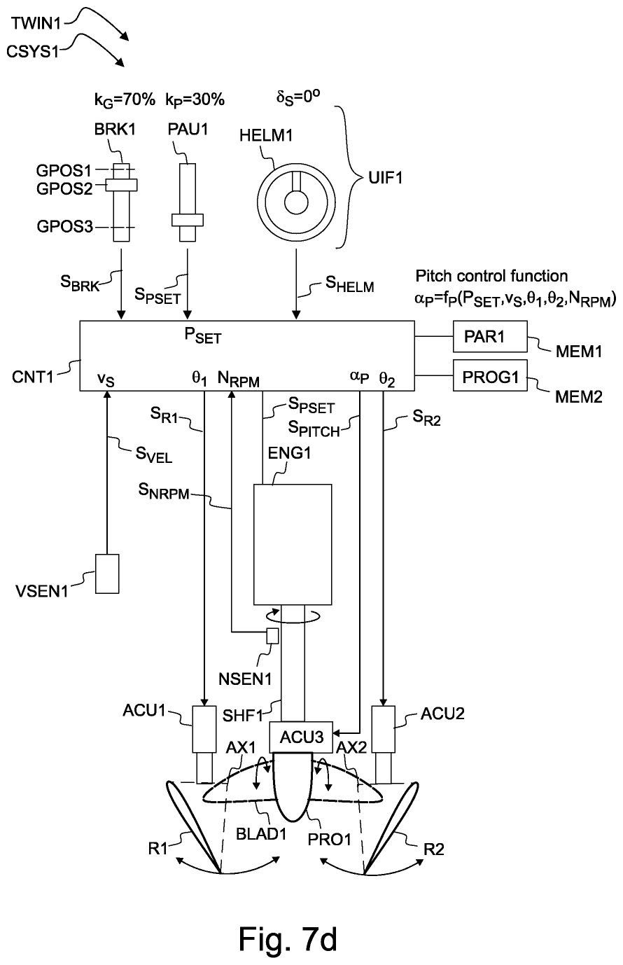

Referring to FIGS. 1 to 3, the ship SHIP1 comprises a hull HUL1, a controllable pitch propeller PRO1, an engine ENG1, a left rudder R1, and a right rudder R2. The propulsion system TWIN1 of the ship comprises the propeller PRO1, the left rudder R1, and the right rudder R2. The propulsion system may be called e.g. as a twin rudder propulsion system or as a propulsion apparatus. The propulsion system TWIN1 may further comprise the engine ENG1. The propulsion system TWIN1 may further comprise a control system (see FIG. 7d) for controlling operation of the propulsion system TWIN1.

The left rudder R1 has a first turning axis AX1. The right rudder R2 has a second turning axis AX2. The left rudder R1 may be turned about the first turning axis AX1. The right rudder R2 may be turned about the second turning axis AX2. The turning axes AX1, AX2 may be substantially vertical.

The left rudder R1 has a trailing edge TE1. The right rudder R2 has a trailing edge TE2. The distance wo between the trailing edges TE1, TE2 may be changed by turning the rudders R1, R2 in opposite directions. The distance WG may be called e.g. as the gate width. The velocity vs of the ship may be changed by changing the gate width WG.

The left rudder R1 has a first rudder blade RB1. The right rudder R2 has a second rudder blade RB2. The rudder blades RB1, RB2 may be substantially vertical. The first axis AX1 may coincide with the first rudder blade RB1, or the first axis AX1 may be laterally displaced with respect to the first rudder blade RB1. The second axis AX2 may coincide with the second rudder blade RB2, or the second axis AX2 may be laterally displaced with respect to the second rudder blade RB2. The lateral displacement between the turning axis and the rudder blade may e.g. facilitate setting narrow gate widths WG.

The left rudder R1 may have a first steering shaft SHF11. The first steering shaft SHF11 may coincide with the first turning axis AX1. The first steering shaft SHF11 may be substantially vertical. The first rudder blade RB1 may be connected to the shaft SHF11 directly or via a connecting element ARM1. The left rudder R1 may comprise a lateral connecting element ARM1 to connect the first rudder blade RB1 to the first steering shaft SHF11. The connecting element ARM1 may define a lateral distance between the first steering shaft SHF11 and the first rudder blade RB1.

The right rudder R2 may have a second steering shaft SHF12. The second steering shaft SHF12 may coincide with the second turning axis AX2. The second steering shaft SHF12 may be substantially vertical. The second rudder blade RB2 may be connected to the shaft SHF12 directly or via a connecting element ARM2. The right rudder R2 may comprise a lateral connecting element ARM2 to connect the second rudder blade RB2 to the second steering shaft SHF12. The connecting element ARM2 may define a lateral distance between the second steering shaft SHF12 and the second rudder blade RB2.

A reference distance (w₀) means the distance between trailing edges of the rudders R1, R2, in a situation where both rudder blades RB1, RB2 are parallel with the longitudinal direction (SX) of the ship. The reference distance (w₀) between trailing edges of the rudders R1, R2 may be e.g. greater than the diameter of the propeller PRO1. The distance between the axes AX1, AX2 may be e.g. smaller than the diameter of the propeller PRO1.

The propeller PRO1 is a controllable pitch propeller. The pitch angle of the blades BLAD1 of the propeller PRO1 is adjustable. The propeller PRO1 has an axis AXO of rotation. The propeller PRO1 has two or more propeller blades BLAD1. The pitch angle ap of the propeller means the pitch angle of the blades BLAD1 of the propeller PRO1. Pitch angle 0° means that the thrust force generated by the rotating propeller in the axial direction (SX) is equal to zero in a situation where the ship velocity vs is zero and the rudder angles θ1,θ2 are equal to 0°. Positive pitch angles provide a thrust force, which pushes the ship forward (ahead) in a situation where the rudder angles θ₁,θ₂ are equal to 0°.

The torque needed to rotate the propeller PRO1 at a predetermined rotation speed N_{RPM} may depend on gate width w_{G} and on the ship velocity vₛ. The pitch angle may be adjusted, so as to keep the torque constant in a situation where the gate width w_{G} and the ship velocity vₛ are changed.

The ship SHIP1 may be controlled e.g. from the navigation bridge BRIDGE1. The operation of the engine ENG1 and the angular positions of the rudders R1, R2 may be controlled by using a user interface UIF1 located on the bridge BRIDGE1.

The ship SHIP1 moves on water SEA1. SRF1 denotes the surface of the water SEA1, i.e. the interface between the water SEA1 and air. SX, SY, and SZ denote orthogonal directions. The longitudinal direction SX may be parallel with the longitudinal direction of the hull HULL1. The transverse direction SY is perpendicular to the longitudinal direction SX. The direction SZ denotes the vertical direction. The ship SHIP1 has a length L_{SHIP1} at the waterline (SRF1). The length L_{SHIP1} may be e.g. in the range of 20 to 400 m. The power of the engine ENG1 may be e.g. in the range of 1 MW to 100 MW. The diameter D_{PRO} of the propeller PRO1 may be e.g. in the range of 2 m to 10 m. The ship SHIP1 may move at a velocity v_{sHIP} with respect to the water SEA1. The velocity vₛ may be e.g. in the range of −5 m/s (astern) to 20 m/s (ahead). The velocity vₛ is the relative velocity of the ship hull HUL1 with respect to the water SEA1. The propeller is driven by the engine. The engine rotates the propeller via a propeller shaft.

The shaft power Pₛ means the mechanical power transmitted from the propeller shaft to the propeller PRO1. The shaft power Pₛ is equal to the propeller torque multiplied by the angular speed of the propeller. The propeller may receive the shaft power from the engine ENG1 via the propeller shaft.

The propulsion system may be rated to provide continuously a maximum nominal shaft power (e.g. during a time period of 24 h). The propeller may be dimensioned such that the propeller may receive the maximum nominal shaft power from the engine via the propeller shaft. The shaft power may be selected from the range of zero power to the maximum nominal shaft power.

The shaft power of the propeller may be provided by the engine ENG1. The output power of the engine ENG1 may match the shaft power of the propeller. Keeping the shaft power constant means that the power of the engine may be kept constant. Keeping the propeller torque constant means that the torque of the engine may be kept constant. Keeping the rotation speed of the propeller constant may mean that the rotation speed of the engine is kept constant.

The shaft power of the propeller may be provided by one or more engines. Keeping the shaft power constant means that the power of the one or more engines may be kept constant. Keeping the propeller torque constant means that the torque of the one or more engines may be kept constant. Keeping the rotation speed of the propeller constant may mean that the rotation speed of the one or more engines is kept constant.

The engine ENG1 may be e.g. a reciprocating internal combustion engine. The reciprocating internal combustion engine may provide sufficient power reliably and at reasonable costs.

The fuel may e.g. fuel oil.

The fuel may also be selected e.g. in order to reduce emissions. The fuel may also be selected e.g. in order to reduce CO₂ emissions. The fuel of the engine may be e.g. ammonia, gaseous fuel, liquified gas, or a combination which comprises ammonia, gaseous fuel, and/or liquified combustible gas. The use of these fuels may make it difficult to change the power at a fast rate.

The engine ENG1 may be operated e.g. according to an optimized set of operating parameters, which may provide e.g. reduced emissions. The present method allows changing the ship velocity without a need to deviate from said optimized set of operating parameters.

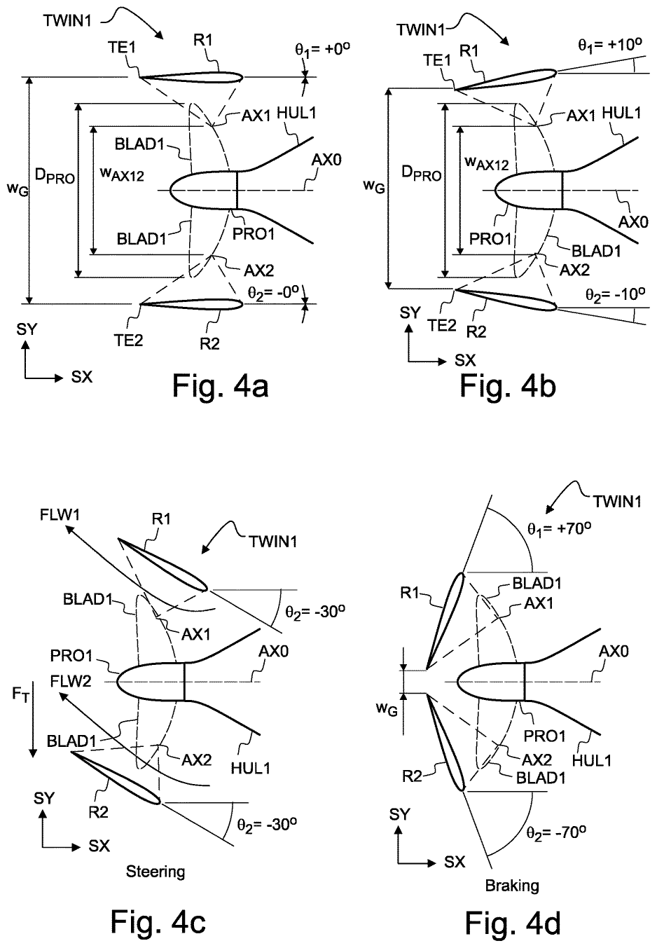

Referring to FIGS. 4a to 4d, the rudders R1, R2 may guide and/or constrict the water flows which are induced by the propeller PRO1. The rudders R1, R2 may cause an adjustable braking effect. The rudders R1, R2 may generate a transverse force F_{T} for steering the ship.

The adjustable braking effect may include e.g. the drag of the rudders R1, R2. The braking effect may include e.g. partial or complete blocking the slipstream by using the rudders R1, R2. The braking effect may include e.g. hydrodynamic forces generated by an interaction between the slipstream and the rudders R1, R2 Referring to FIG. 4a, the first rudder angle θ₁ may denote the angular orientation of the chord line of the left rudder R1, with respect to the longitudinal direction SX. The second rudder angle θ₂ may denote the angular orientation of the chord line of the right rudder R2, with respect to the longitudinal direction SX.

The reference gate width w₀, i.e. the distance wo between the trailing edges TE1,TE2 of the rudders R1, R2 at the zero rudder angle (θ₁=0°,θ₂=0°) may be greater than the diameter D_{PRO} of the propeller PRO1. The distance w_{AX12} between the first turning axis AX1 and the second turning axis AX2 may be smaller than the reference gate width w₀. The distance w_{AX12} between the first turning axis AX1 and the second turning axis AX2 may be smaller than the diameter _{DPRO} of the propeller PRO1.

The rudders R1, R2 may be oriented during normal cruising such that the rudders R1, R2 generate low or minimum drag. The rudder angles θ₁,θ₂ may be e.g. substantially equal to 0°.

Referring to FIG. 4b, the left rudder R1 may be turned counterclockwise, and the right rudder R2 may be turned clockwise, so as to cause a braking effect. For example, the first rudder angle θ1 may be substantially equal to +10°, and the second rudder angle θ₂ may be substantially equal to −10°. The gate width WG during braking may be smaller than the gate width we during normal cruising.

Referring to FIG. 4c, both rudders R1, R2 may be turned in the same direction, i.e. either clockwise or counterclockwise, so as to cause a transverse steering force F_{T}. For example, the first rudder angle θ₁ may be substantially equal to −30°, and the second rudder angle θ₂ may be substantially equal to −30°.

Referring to FIG. 4d, the left rudder R1 may be turned counterclockwise, and the right rudder R2 may be turned clockwise, so as to cause a braking effect. For example, the first rudder angle θ₁ may be substantially equal to +70°, and the second rudder angle θ₂ may be substantially equal to −70°. For effective braking, the gate width wG may be e.g. smaller than 50% of the diameter DPRO of the propeller PRO1.

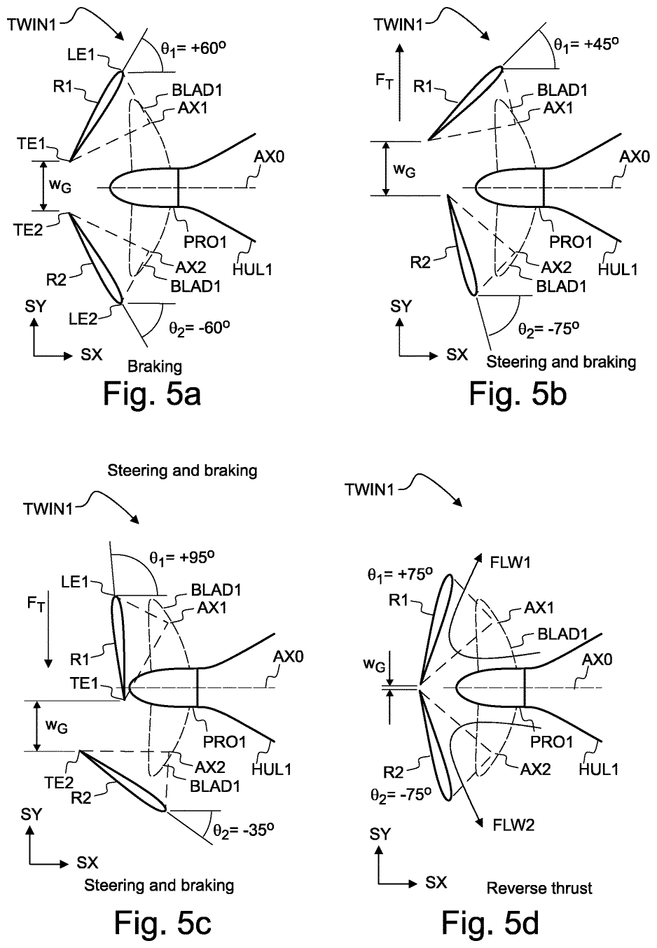

Referring to FIG. 5a, the left rudder R1 may be turned counterclockwise, and the right rudder R2 may be turned clockwise, so as to cause a braking effect. For moving straight ahead, the average value (θ₁+θ₂)/2 of the rudder angles may be substantially equal to zero in order to avoid generating a transverse steering force.

Referring to FIGS. 5b and 5c, the gate width we may be e.g. smaller than 50% of the diameter DPRO of the propeller PRO1, and the average value (θ₁+θ₂)/2 of the rudder angles may be substantially different from zero, in order to provide a combined steering and braking effect.

Referring to FIG. 5d, the gate width we may even be so small that the propeller PRO1 and the rudders R1, R2 cause a reversed thrust force. The symbols FLW1, FLW2 denote the water flow of which is induced by the propeller PRO1, and which is guided by the rudders R1, R2.

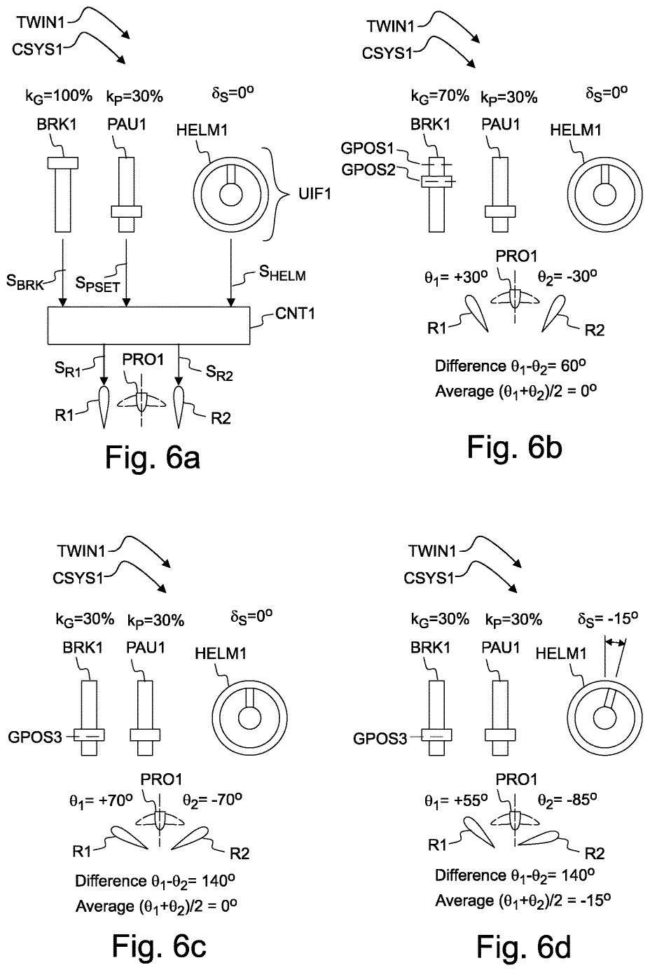

Referring to FIG. 6a, the propulsion system TWIN1 of the ship SHIP1 may comprise a control system CSYS1 for controlling operation of the propulsion system TWIN1. The control system CSYS1 may comprise a user interface UIF1 and a control unit CNT1. The user interface UIF1 may be located e.g. on the navigation bridge BRIDGE1. The user interface UIF1 may comprise an input device HELM1 for adjusting the average value (θ₁+θ₂)/2 of the rudder angles. The input device HELM1 may be e.g. a steering wheel or a joystick. The user interface UIF1 may comprise an input device BRK1 for controlling the gate width WG. The input device BRK1 may comprise e.g. a brake lever. The user interface UIF1 may comprise an input device PAU1 for adjusting the shaft power and/or rotation speed of the propeller PRO1. The input device PAU1 may comprise e.g. a manual control lever. The input devices HELM1, BRK1, PAU1 may be implemented e.g. as physical devices (e.g. helm, levers, potentiometer knobs). The input devices HELM1, BRK1, PAU1 may also be implemented e.g. as virtual control elements on a touchscreen.

The user interface UIF1 may provide control signals S_{HELM}, S_{BRK}, S_{PSET} for the control unit CNT1, based on user input received via the user interface UIF1. The steering signal S_{HELM} may be indicative of a target value of the average value (θ₁+θ₂)/2 of the rudder angles. The braking signal S_{BRK} may be indicative of a target value of braking effect. The target power signal S_{PSET} may be indicative of a target value (P₁, P_{sET}) of the shaft power.

The control unit CNT1 may comprise one or more data processors, for executing computer program code. The control unit CNT1 may form a first rudder control signal S_{R1} for controlling the rudder angle θ₁ of the left rudder R1. The control unit CNT1 may form a second rudder control signal S_{R2} for controlling the rudder angle θ₂ of the right rudder R2. The control unit CNT1 may form the rudder control signals S_{R1}, S_{R2} e.g. based on the control signals S_{HELM}, S_{BRK}, S_{PSET}. The rudder control signals S_{R1}, S_{R2} may be used for controlling actuators ACU1, ACU2 of the rudders R1, R2.

Referring to FIG. 6b, the steering angle δ_{S} may refer to an angular position of a steering element of the steering input device HELM1. In particular, the steering angle δ_{S} may refer to the angular position of a steering wheel. The steering input device HELM1 may be set to the steering angle δ_{S}=0°, for travelling straight ahead. The brake input device BRK1 may have a normal first position GPOS1 for normal cruising. At the first position GPOS1, the gate width WG of the rudders R1, R2 may be set to minimize drag forces. For example, the rudder angles θ₁,θ₂ may be substantially equal to zero at the first position GPOS1. The power adjusting device PAU1 may be set to a position, which corresponds to a predetermined shaft power level (P₁), e.g. 30% of the maximum nominal shaft power P_{MAX}.

The symbol k_{P} may denote a ratio of the shaft power Pₛ to the maximum nominal shaft power P_{MAX}. The symbol k_{G} may denote the ratio of the gate width w_{G} to the reference gate width w₀.

The gate width wG of the rudders R1, R2 may be reduced by changing the position of the brake input device BRK1 e.g. from a first position GPOS1 to a second position GPOS2. The second position GPOS2 may correspond e.g. to a situation where the difference (θ₁−θ₂) between the rudder angles is equal to 60°. The average value (θ₁+θ₂)/2 of the rudder angles may be substantially equal to zero, according to the steering angle δ_{S}=0°, for travelling straight ahead.

Referring to FIG. 6c, the gate width wo of the rudders R1, R2 may be further reduced by changing the position of the brake input device BRK1 to a third position GPOS3. The position GPOS3 may correspond e.g. to a situation where the difference (θ₁−θ₂) between the rudder angles is equal to 140°. The average value (θ₁+θ₂)/2 of the rudder angles may be substantially equal to zero, according to the steering angle δ_{S}=0°, for travelling straight ahead.

Referring to FIG. 6d, the ship SHIP1 may be turned to the right (clockwise) e.g. by turning the steering element HELM1 to the right (clockwise). The steering element HELM1 may be turned e.g. to the angular position δ_{S}=+15°. The control system CSYS1 may turn the rudders R1, R2 such that the average value (θ₁+θ₂)/2 of the rudder angles deviates from zero, corresponding to the angular position (e.g. δ_{S}=+15°) of the steering element HELM1. The rudders R1, R2 may cause a force, which has a transverse steering component and also a braking component. The gate width we may be e.g. less than 50% of the reference gate width w₀.

FIG. 7a illustrates an effect of a change of the ship velocity vs on the torque M_{P} needed to rotate the propeller PRO1 at a constant rotation speed N_{RPM}, in a situation where the gate width w_{G} is kept constant, and the pitch angle α_{P} is kept constant. The torque M_{P} needed to rotate the propeller PRO1 at the constant rotation speed N_{RPM} may increase from a lower torque value M_{P,1} to a higher torque value M_{P,2} when the ship velocity vₛ is decreased from a higher value v₁ to a lower value v₂.

FIG. 7b illustrates an effect of a change of the gate width w_{G} on the torque M_{P} needed to rotate the propeller PRO1 at a constant rotation speed N_{RPM}, in a situation where the pitch angle α_{P} of the propeller PRO1 is kept constant, and the ship velocity vₛ is kept constant. The torque M_{P} needed to rotate the propeller PRO1 at the constant rotation speed N_{RPM} may increase from a lower torque value M_{P,1} to a higher torque value M_{P,2} when the gate width w_{G} is decreased from a higher value w_{G,1} to a lower value w_{G,2}.

FIG. 7c illustrates an effect of a change of the pitch angle α_{P} of the propeller PRO1 on the torque M_{P} needed to rotate the propeller PRO1 at a constant rotation speed N_{RPM}, in a situation where the gate width w_{G} is kept constant, and the ship velocity vₛ is kept constant. The torque M_{P} needed to rotate the propeller PRO1 at the constant rotation speed N_{RPM} may decrease from a higher torque value M_{P,1} to a lower torque value M_{P,2} when the pitch angle α_{P} is decreased from a higher value α_{P,1} to a lower value α_{P,2}.

The effect shown in FIG. 7c may be arranged to compensate the effects shown in FIGS. 7a and 7b. The control system CSYS1 may be arranged to adjust the pitch angle α_{P} so as to keep the propeller torque M_{P} and the rotation speed N_{RPM} constant in a situation where the gate width w_{G} and the ship velocity vₛ are changed.

Referring to FIG. 7d, the control system CSYS1 may comprise an actuator ACU1 for turning the left rudder R1. The control system CSYS1 may comprise an actuator ACU2 for turning the right rudder R2. The control system CSYS1 may comprise an actuator ACU3 for changing the pitch angle of the blades BLAD1 of the propeller PRO1. The actuators ACU1, ACU2, ACU3 may be e.g. hydraulic actuators or electromechanical actuators. The actuators ACU1, ACU2, ACU3 may be arranged to generate high forces, e.g. greater than 10 kN, greater than 100 kN, or even greater than 1 MN.

The control system CSYS1 may form a first rudder control signal S_{R1} for controlling the rudder angle θ₁ of the left rudder R1. The signal S_{R1} may be indicative of the target value of the rudder angle θ₁ of the left rudder R1. The signal S_{R1} may be sent from the control unit CNT1 to the actuator ACU1.

The control system CSYS1 may form a second rudder control signal S_{R2} for controlling the rudder angle θ₂ of the right rudder R2. The signal S_{R2} may be indicative of the target value of the rudder angle θ₂ of the right rudder R2. The signal S_{R2} may be sent from the control unit CNT1 to the actuator ACU2.

The control system CSYS1 may form a pitch control signal S_{PITCH} for controlling the pitch angle α_{P} of the blades BLAD1 of the propeller PRO1. The signal S_{PITCH} may be indicative of the target value of the pitch angle α_{P} of the propeller blades. The signal S_{PITCH} may be sent from the control unit CNT1 to the actuator ACU3.

The engine ENG1 may rotate the propeller PRO1 by using a propeller shaft SHF1. The control system CSYS1 may comprise a rotation speed sensor NSEN1 for measuring the rotation speed N_{RPM} of the propeller shaft SHF1. The engine ENG1 may be coupled to the propeller shaft SHF1 directly or via a gearbox. The rotation speed sensor NSEN1 may also be arranged to measure the rotation speed of the engine ENG1. The rotation speed sensor NSEN1 may provide a signal S_{NRPM}, which is indicative of the rotation speed N_{RPM} of the propeller shaft SHF1, and which is also indicative of the rotation speed of the engine ENG1.

The control system CSYS1 may comprise a velocity sensor VSEN1 for measuring the relative velocity vs of the ship SHIP1 with respect to the water SEA1. The velocity sensor VSEN1 may provide a velocity signal S_{VEL}, which is indicative of the measured relative velocity vₛ of the ship SHIP1 with respect to the water SEA1. The velocity sensor VSEN1 may be implemented e.g. by a pitot tube and/or by an ultrasonic speed sensor. In case of non-moving water, the velocity sensor VSEN1 may also be implemented e.g. by a GPS navigation sensor (GPS means Global Positioning System).

The control unit CNT1 may comprise one or more data processors for executing computer program code PROG1. The control system CSYS1 may comprise a memory MEM2 for storing the computer program code PROG1. The control unit CNT1 may be configured to form the control signals S_{R1}, S_{R2}, S_{PITCH} according to one or more sensor signals S_{VEL}, S_{NRPM}, and according to one or more control signals S_{HELM}, S_{BRK}, S_{PSET} received via the user interface UIF1.

The velocity vₛ of the ship SHIP1 may be changed by using a braking effect of the rudders R1, R2. The magnitude of the braking effect may be changed by changing the gate width w_{G}. Changing the gate width w_{G} and changing the velocity vₛ of the ship SHIP1 may change the propeller torque, i.e. the torque needed to rotate the propeller PRO1 at a predetermined constant rotation speed N_{RPM}. The propeller torque may also depend on the pitch angle α_{P} of the blades BLAD1 of the propeller PRO1. The pitch angle α_{P} may be adjusted so as to keep the propeller torque constant, in a situation where the gate width w_{G} is changed. Thus, also the power of the engine ENG1 may be kept constant. Thus, emissions and/or disturbances caused by a change of the engine power may be reduced or avoided.

The propulsion system TWIN1 may have a first operating mode MODE1, where the gate width w_{G} is kept substantially constant, and the shaft power Pₛ is varied.

The propulsion system TWIN1 may have a second operating mode MODE2, where the shaft power Pₛ is kept constant, and the gate width w_{G} is varied.

The pitch angle α_{P} of the propeller PRO1 may be adjusted, so as to keep the shaft power Pₛ is constant, in a situation where the gate width w_{G} is changed. The control unit CNT1 may determine a suitable pitch angle α_{P} of the propeller PRO1 from the rudder angles θ₁,θ₂, from the measured velocity vs of the ship, from the selected shaft power PSET, and from the rotation speed N_{RPM}. The actuator ACU3 may be arranged to change the pitch angle α_{P} of the blades BLADE1 of the propeller PRO1 according to the determined pitch angle α_{P}.

The control unit CNT1 may be configured to form a pitch control signal S_{PITCH}e.g. based on signals S_{PSET}, S_{VEL}, S_{HELM}, S_{BRK}, S_{NRPM}. The control unit CNT1 may be configured to determine the pitch angle α_{P} by using a pitch control function f_{P}(P_{sET}, vₛ,θ₁,θ₂, N_{RPM}). The pitch control function may be determined e.g. by experimental tests and/or by simulations. The control system CSYS1 may comprise a memory MEM1 for storing the pitch control function f_{P}(P_{sET}, vₛ,θ₁,θ₂, N_{RPM}). The pitch control function may be stored in the memory MEM1 e.g. as a lookup table. The pitch control function may also be stored in the memory MEM1 e.g. as parameters PAR1, which define the pitch control function. The pitch control function may be e.g. a regression function of multiple variables P_{sET}, vₛ,θ₁,θ₂, N_{RPM}. The pitch control function may be e.g. a polynomial function or a piecewise polynomial function.

The selected shaft power value P₁, P_{sET} may be e.g. in the range of 10% to 70% of the maximum nominal shaft power P_{MAX}, advantageously in the range of 20% to 40%. The selected power value P₁, P_{sET} may be e.g. substantially equal to 30% of the maximum nominal shaft power P_{MAX}.

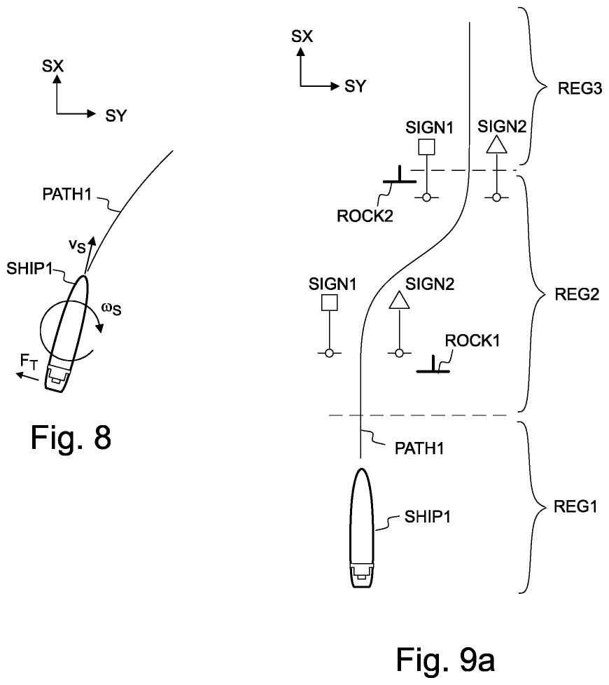

Referring to FIG. 8, The ship may travel along a navigation path PATH1 at a velocity vₛ. The rudders R1, R2 may cause a transverse force F_{T} for steering the ship. The ship may turn at an angular speed ωₛ.

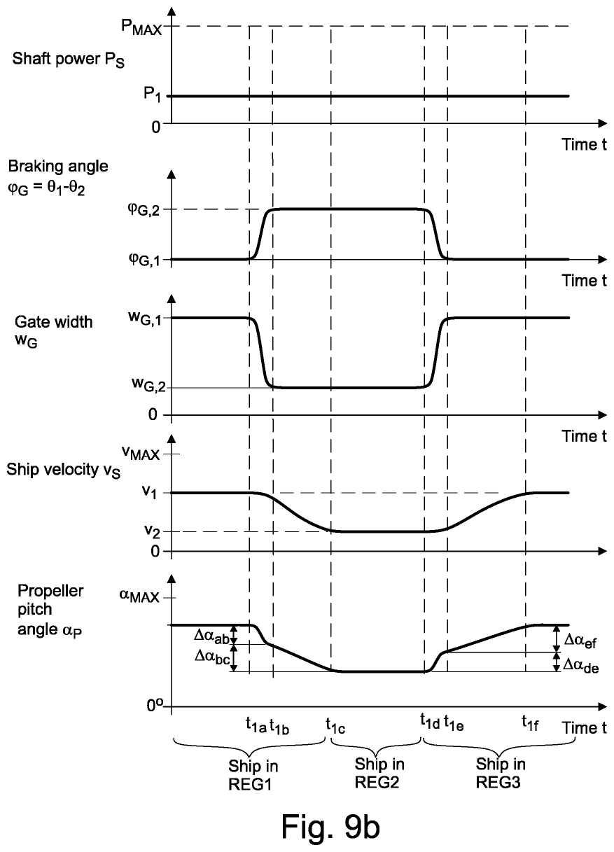

Referring to FIG. 9a, the ship SHIP1 may move along a navigation path PATH1. The navigation path PATH1 may be determined e.g. according to navigation marks SIGN1, SIGN2 and/or according to obstacles ROCK1, ROCK2. The path PATH1 may comprise one or more curved sections. The velocity of the ship SHIP1 may be reduced e.g. in order to navigate along the curved sections. The path PATH1 may have a first region REG1, which allows cruising at a normal cruising velocity. The PATH1 may have a second region REG2, where the velocity vₛ of the ship SHIP1 is reduced. The PATH1 may have a third region REG3, where the velocity may be increased.

FIG. 9b shows, by way of example, temporal evolution of shaft power, braking angle, gate width, ship velocity, and pitch angle in different regions of the navigation path PATH1.

The ship SHIP1 is moving at a first velocity v₁ at the time t₁ₐ. The ship may be in the first region REG1 of the path PATH1. The shaft power P1 may be substantially equal to a first value P₁. The first value P₁ may be e.g. in the range of 10% to 50% of the maximum nominal shaft power P_{MAX}. The first value P₁ may be e.g. in the range of 20% to 40% of the maximum nominal shaft power P_{MAX}. The first value P₁ may be e.g. approximately 30% of the maximum nominal shaft power P_{MAX}.

Reducing the velocity vₛ may be started at the time t₁ₐ by turning the rudders R1, R2 in opposite directions. The braking angle φ_{G}=θ₁−θ₂ may be increased from a first value φ_{G,1} to a second value φ_{G,1}. The gate width w_{G} may be reduced from a first value w_{G,1} to a second reduced value w_{G,2}. The first gate width w_{G,1} may be e.g. equal to the reference value w₀, or equal to another optimum value, which may e.g. minimize fuel consumption. The first gate width w_{G,1} may correspond e.g. to the first position GPOS1 of the input device BRK1. The second gate width w_{G,2} may correspond e.g. to the second position GPOS2 of the input device BRK1. The ship velocity vₛ may be changed from a first higher value v₁ to a second lower value v₂. The velocity vₛ may start to decrease as soon as the gate width w_{G} is smaller than the first value w_{G,1}. The ship may be optionally steered by changing the average (θ₁+θ₂)/2 of the rudder angles.

The torque needed to rotate the propeller PRO1 at a predetermined rotation speed N_{RPM} may increase with decreasing gate width w_{G}. The control system CSYS1 may compensate the increased drag of the rudders R1, R2 by decreasing the pitch angle α_{P} of the blades BLAD1 of the propeller PRO1, so as to keep the torque and the shaft power Pₛ constant.

Turning of the rudders R1, R2 is not an infinitely fast operation. Turning of the rudders R1, R2 takes some time. The gate width value w_{G,2} may be attained e.g. at a time t_{1b}. The pitch angle α_{P} may be reduced by Δα_{ab} between the times tₐ and t_{b}, so as to keep the torque of the propeller PRO1 constant.

The velocity vₛ may continue to decrease between times t_{b} and t_{c}, due to the braking effect of the rudders R1, R2. A reduced velocity value v₂ may be attained at the time t_{c}. The reduced velocity v₂ may be attained e.g. when the ship SHIP1 enters the second region REG2 of the navigation path PATH1, or already before the ship SHIP1 enters the second region REG2.

The propeller torque may increase with decreasing velocity vs. The pitch angle α_{P} may be reduced by Δα_{bc} between the times t_{1b} and t_{1c}, so as to keep the propeller torque constant.

The ship SHIP1 may navigate along the second region REG2 of the path PATH1 at the reduced velocity v₂. The shaft power Pₛ may be kept substantially equal to the first value P₁.

The shaft power Pₛ at the second lower velocity v₂ may remain equal to the shaft power Pₛ at the first higher velocity v₂, thanks to using the controlled pitch angle α_{P} to compensate an effect of the change of gate width wo on the propeller torque, and to compensate an effect of the change of velocity vs on the propeller torque. The rotation speed N_{RPM} and the torque M_{P} may be kept constant.

The gate width we may be increased from the reduced value w_{G,2} back to the higher value w_{G,1} between times t_{1d} and t₁ₑ. Increasing the gate width w_{G} may reduce drag, and may allow the velocity vₛ of the ship SHIP1 to increase. The velocity vₛ of the ship SHIP1 may be increased from the lower value v₂ to the higher value v₁ between the times t_{1d} and t_{1f}. The velocity vₛ of the ship SHIP1 may attain the higher value v₁ at the time t_{1f}.

The increased gate width w_{G} and the increased velocity vₛ may reduce the torque M_{P} needed to rotate the propeller PRO1 at the selected constant rotation speed N_{RPM}. The pitch angle α_{P} may be increased so as to compensate the effects of the increased gate width w_{G} and the increased velocity vₛ on the propeller torque M_{P}. The pitch angle α_{P} may be increased by the amount Δα_{de} between the times t_{1d} and t₁ₑ. The pitch angle α_{P} may be increased by the amount Δα_{ef} between the times t₁ₑ and t_{1f}.

The ship velocity vₛ may be changed by changing the gate width w_{G} of the rudders R₁, R₂. The ship velocity vs may be changed from a higher value v₁ to a lower value v₂ by reducing the gate width w_{G}. The ship velocity vₛ may be changed from a lower value v₂ to a higher value v₁ by increasing the gate width w_{G}. The propulsion system TWIN1 may have an operating mode MODE2, where the pitch angle α_{P} is adjusted so as to keep the engine power Pₛ constant in a situation where the gate width w_{G} is changed. Keeping the engine power Pₛ may reduce emissions and/or may improve operating reliability.

The ship velocity vs may be changed from a higher value v₁ to a lower value V₂ by reducing the gate width w_{G}. The shaft power Pₛ may be kept substantially constant e.g. in a situation where the velocity vₛ is reduced by approximately 50%. The deviation between the shaft power Pₛ and the target value P₁ (PSET) may be kept e.g. smaller than 10%, advantageously smaller than 5%, and preferably smaller than 2%, in a situation where the velocity vₛ is decreased by approximately 50%. The velocity may be reduced e.g. by 30% to 70%. The control system (SYS1) may be arranged to change the pitch angle (α_{P}) of the propeller (PRO1) such that the absolute value of the difference (P₁−Pₛ) between the shaft power (Pₛ) and the first power value (P₁) remains smaller than 10% of the first power value (P₁) in a situation where the velocity (vₛ) of the ship (SHIP1) is changed from a first higher velocity value (V₁) to a second lower velocity value (v₂) by changing the difference (θ₁−θ₂) between the rudder angles (θ₁,θ₂), wherein the ratio of the lower second velocity value (v₂) to the first higher velocity value (v₁) is in the range of 30% to 70%.

The ship velocity vₛ may be changed from a lower value v₂ to a higher value v₁ by increasing the gate width w_{G}. The shaft power Pₛ may be kept substantially constant e.g. in a situation where the velocity vₛ is increased by approximately 100%. The deviation between the shaft power Pₛ and the target value P₁ (PSET) may be kept e.g. smaller than 10%, advantageously smaller than 5%, and preferably smaller than 2%, in a situation where the velocity vs is increased by approximately 100%. The lower velocity may be e.g. in the range of 30% to 70% of the higher velocity. The control system (SYS1) may be arranged to change the pitch angle (α_{P}) of the propeller (PRO1) such that the absolute value of the difference (P₁−Pₛ) between the shaft power (Pₛ) and the first power value (P₁) remains smaller than 10% of the first power value (P₁) in a situation where the velocity (vₛ) of the ship (SHIP1) is changed from a lower velocity value (v₂) to a higher velocity value (v₁) by changing the difference (θ₁−θ₂) between the rudder angles (θ₁,θ₂), wherein the ratio of the lower velocity value (v₂) to the higher velocity value (v₁) is in the range of 30% to 70%.

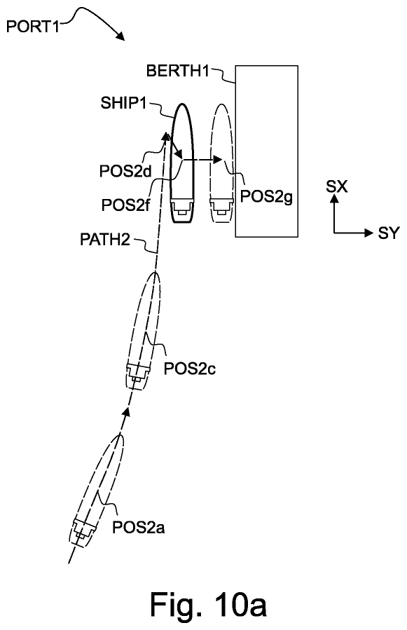

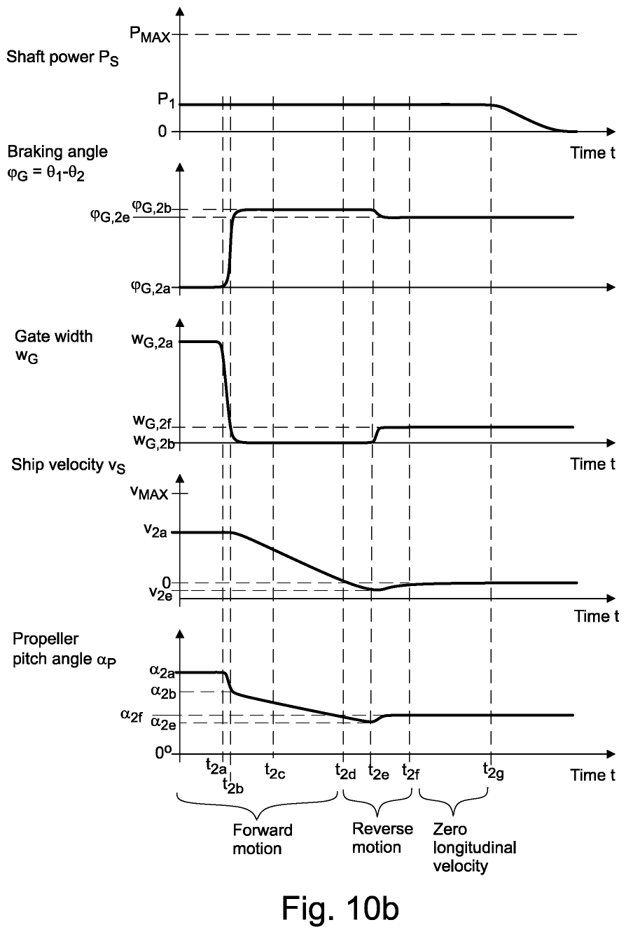

Referring to FIG. 10a, the ship SHIP1 may be maneuvered e.g. in a port PORT1. The ship SHIP1 may approach a berth BERTH1. The path PATH2 of the ship SHIP1 may comprise waypoints POS2a, POS2b, POS2c, POS2d, POS2f, POS2g.

Referring to FIG. 10b, the ship may have a first velocity V₂ₐ at the waypoint POS2a at the time t₂ₐ. The shaft power Pₛ may be kept equal to a first value P1. The gate width we may be reduced from a first value w_{G,2a} to a second value w_{G,2b} between the times t₂ₐ and t_{2b}, so as to reduce the velocity vₛ from the first value v₂ₐ. The braking angle may be increased from a first value φ_{G,2a} to a second value φ_{G,2b}.

The ship may be optionally steered by changing the average (θ₁+θ₂)/2 of the rudder angles. The velocity vs of the ship may become zero at the waypoint POS2d at the time t_{2d}.

The ship may also be optionally moved in the reverse longitudinal direction astern, −SX) between the times t_{2d} and t_{2f}. The ship may have a negative velocity v₂ₑ at the time t₂ₑ. The gate width we may be slightly increased at the time t2e to a third value w_{G,2f}, so as to stop the movement of the ship in the reverse direction. The braking angle may be decreased from the second value φ_{G,2b} to a third value φ_{G,2f}. The velocity vₛ of the ship may become zero again at the waypoint POS2f at the time t_{2f}.

Once the longitudinal movement has been substantially stopped, the ship may be moved in the transverse direction (SY) e.g. by using one or more maneuvering thrusters, by using one or more tugboats, and/or by using mooring cables. The ship may be moved in the transverse direction (SY) to the berth BERTH1 e.g. after the time t_{2f}. The stern of the ship may be moved in the transverse direction (SY) also by using a transverse force F_{T} generated by the propulsion system TWIN1. The shaft power Pₛ may be decreased from the constant value P₁ to zero e.g. after the time t_{2g}, e.g. after the ship is secured to the berth. Rotation of the crankshaft of the engine ENG1 may be stopped e.g. after the time t_{2g}.

During maneuvering, the velocity vₛ of the ship may be changed by changing the gate width w_{G} of the rudders R₁, R₂, wherein the engine power Ps may be kept constant by adjusting the pitch angle α_{P} of the propeller.

The ship velocity vs may be changed by changing the gate width w_{G} of the rudders R₁, R₂. The ship velocity vs may be changed from a higher value V₂ₐto a lower value (e.g. zero) by reducing the gate width w_{G}. The propulsion system TWIN1 may have the operating mode MODE2, where the pitch angle α_{P} is adjusted so as to keep the engine power Pₛ constant in a situation where the gate width w_{G} is changed. The propeller PRO1 may have e.g. pitch angles α₂ₐ, α_{2b}, α₂ₑ, α_{2f} at times t₂ₐ, t_{2b}, t₂ₑ, t_{2f}, respectively. The pitch angle may be reduced from first value α₂ₐ to second value α_{2b} to compensate reduction of the gate width. The pitch angle may be reduced from the second value α_{2b} to a third value α₂ₑ to compensate reduction of the velocity vs.

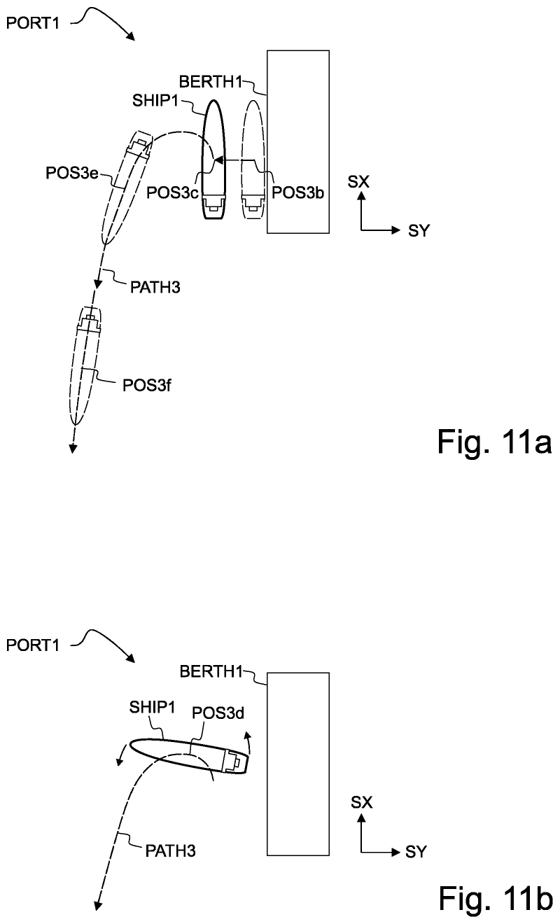

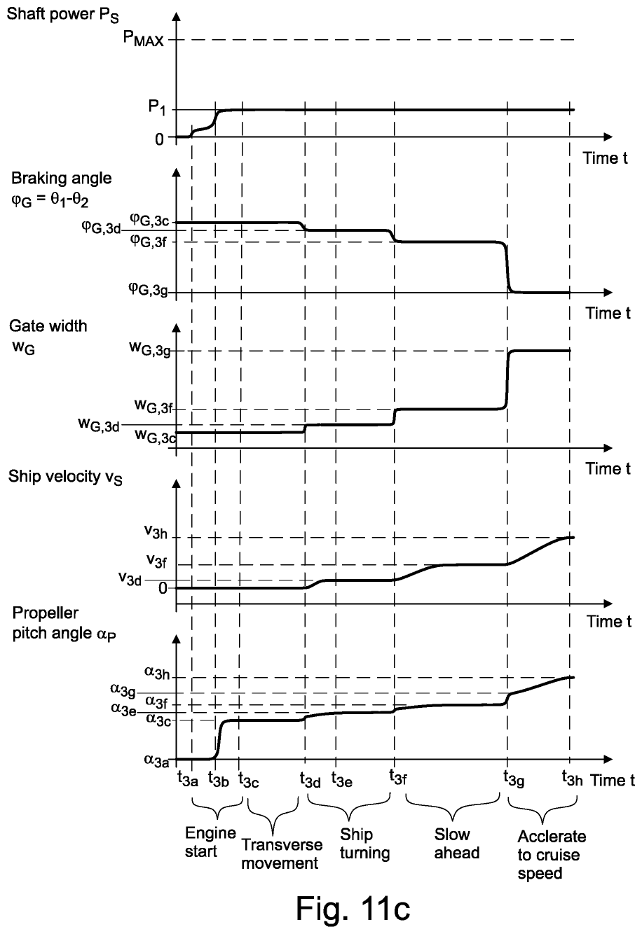

Referring to FIGS. 11a and 11b, the ship SHIP1 may leave the berth BERTH1. The path PATH3 of the ship SHIP1 may comprise waypoints POS3b, POS3c, POS3d, POS3e, POS3f.

Referring to FIG. 11c, rotation of the crankshaft of the engine ENG1 and combustion of fuel in the cylinders of the engine ENG1 may be started at the time t₃ₐ. The gate width w_{G} of the rudder R₁, R₂ may be set so as to reduce or minimize thrust force of the propulsion system TWIN1. The shaft power Ps may reach the selected power value P₁ at the time t_{3b}. Operation of the engine ENG1 may be allowed to stabilize between the times t_{3b} and t_{3d}.

Mooring cables may be released at the time t_{3d}. The ship may be moved in the transverse direction (−SY) away from the berth between the times t_{3b} and t_{3d}. The ship may be moved in the transverse direction (−SY) e.g. by using one or more maneuvering thrusters, and/or by using one or more tugboats. The stern of the ship may be moved in the transverse direction (−SY) also by using a transverse force F_{T} generated by the propulsion system TWIN1.

The gate width w_{G} may be increased from a value w_{G,3c} to a value w_{G,3d} at the time t_{3d}, so as to start the movement of the ship in the forward direction (SX, ahead). The ship may be optionally steered by using transverse forces F_{T} generated by the propulsion system CSYS1. The ship may be optionally turned between the times t_{3d} and t_{3f}.

The gate width we may be increased e.g. to a value w_{G,3f} at the time t_{3f}, so as to increase the velocity vₛ of the ship. The gate width we may be increased e.g. to a value w_{G,3g} at the time t_{3g}, so as to increase the velocity vₛ of the ship. The velocity of the ship may reach e.g. a cruising speed value v₃ₕ at the time t₃ₕ. The braking angle may have e.g. a value φ_{G,3c} at the time t_{3c}, a value φ_{G,3d} at the time t_{3d}, a value φ_{G,3f} at the time t_{3f}, and a value φ_{G,3g} at the time t_{3g}.

During maneuvering, the velocity vₛ of the ship may be changed by changing the gate width w_{G} of the rudders R₁, R₂, wherein the shaft power Ps may be kept constant by adjusting the pitch angle α_{P} of the propeller.

The ship velocity vs may be changed by changing the gate width w_{G} of the rudders R₁, R₂. The ship velocity vₛ may be changed from a lower value (e.g. zero) to a higher value (V_{3d}, V_{3f}, V₃ₕ) by increasing the gate width w_{G}. The propulsion system TWIN1 may have the operating mode MODE2, where the pitch angle α_{P} is adjusted so as to keep the engine power Pₛ constant in a situation where the gate width w_{G} is changed. The propeller PRO1 may have e.g. pitch angles α₃ₐ, α_{3c}, α₃ₑ, α_{3f}, α_{3g}, α₃ₕ at times t₂ₐ, t_{2b}, t₂ₑ, t_{2f}, t₂ₑ, t_{2f}, respectively.

An optimum gate width wo for minimizing fuel consumption at the cruising speed may be slightly different from the reference width wo. The rudder angles may be arranged to deviate slightly from the zero angle, so that the interaction between the rudders and the slipstream of the propeller may generate an additional thrust force, which pushes the ship in the forward direction (SX). The twin rudder propulsion system may be arranged to generate an additional forward thrust during forward movement at a cruising velocity. The rudder angles may be set such that interaction of the propeller slipstream with the rudders generates an additional hydrodynamic thrust force, which pushes the ship in the forward direction, in addition to the thrust force of the propeller.

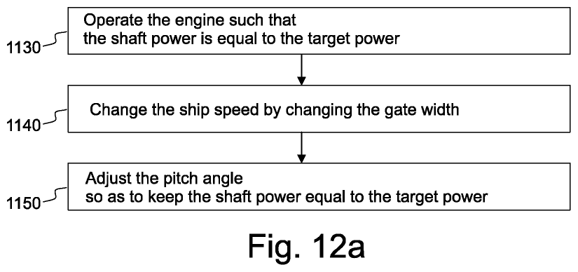

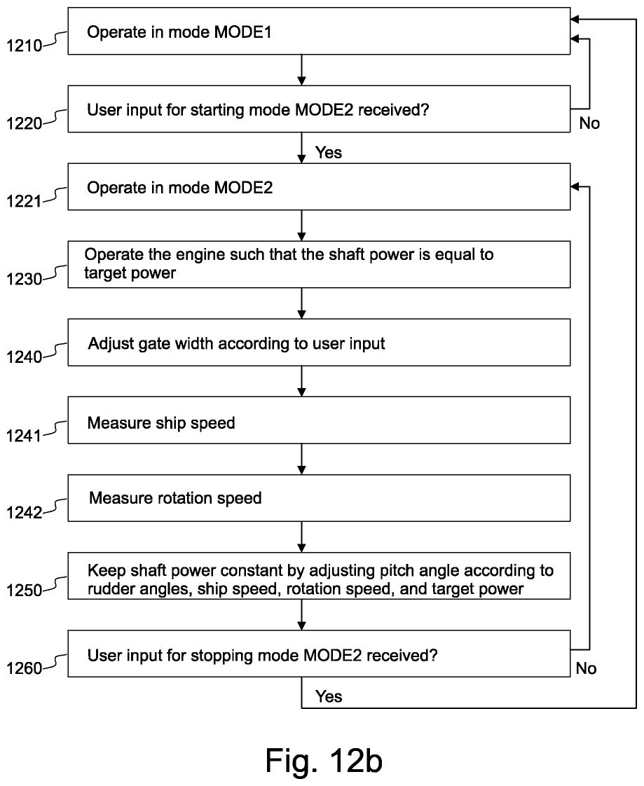

FIG. 12a shows, by way of example, method steps for changing the ship velocity vₛ. Operation in the constant power operating mode MODE2 may comprise stabilizing operation of the engine ENG1 at the selected power value P₁. The propeller PRO1 may be rotated by the engine ENG1 at a selected rotation speed N_{RPM}, and at the selected shaft power value P₁ (step 1130). The velocity vₛ of the ship SHIP1 may be changed by changing the gate width wG (step 1140). The pitch angle α_{P} may be adjusted so as to keep the shaft power Pₛ equal to the selected power value P₁ (step 1150). The pitch angle α_{P} may be adjusted so as to keep the propeller torque M_{P} constant in the situation where the gate width w_{G} is changed and the rotation speed N_{RPM} of the propeller is kept constant.

The control system SYS1 may comprise an input device BRK1 for receiving user input (k_{B}) for changing the braking effect of the rudders R1, R2. The control system SYS1 may be configured to start operation in the constant power operating mode MODE2 e.g. when user input (k_{B}) for changing the braking effect is received via the input device BRK1, in a situation where the shaft power (Pₛ) is in a predetermined range (e.g. in the range of 10% to 30% of the maximum nominal shaft power P_{MAX}.

The control system SYS1 may comprise an input device PAU1 for receiving user input (k_{P}) for changing the shaft power Pₛ. The control system SYS1 may be configured to stop operation in the constant power operating mode MODE2 e.g. when user input (k_{P}) for changing the shaft power Pₛ is received via the input device PAU1. User input for changing power indicates that the user wishes to change power. User input for changing power may be used also as user input for stopping operation in the constant power operating mode MODE2.

FIG. 12b shows, by way of example, method steps for operating the propulsion system in the variable power mode MODE1, and in the constant power mode MODE2.

Operation may be started in the variable power operating mode MODE1 (step 1210).

The method may comprise checking whether user input for starting the constant power operating mode is received (step 1220).

Operation in the constant power operating mode MODE2 may be started in an instance where user input for starting the constant power operating mode is received (step 1221).

User input for starting operation in the constant power operating mode MODE2 may be received e.g. via the user interface UIF1. User input for starting operation in the constant power operating mode MODE2 may be received e.g. by pushing a button or setting the position of a control element of the user interface UIF1

Changing the position of an element of the input device BRK1 may be used as a command for changing the gate width w_{G}, and also as a command for starting operation in the constant power operating mode MODE2.

The engine ENG1 may be operated such that the shaft power Pₛ is equal to a selected target power PSET (step 1230).

The gate width wo and the rudder angles θ₁,θ₂ may be adjusted according to user input (step 1240). The gate width we may be reduced or increased by turning the rudders R1, R2. The velocity vs of the ship SHIP1 may be reduced by reducing the gate width w_{G}. The velocity vs of the ship SHIP1 may be increased by increasing the gate width w_{G}. The ship may also be steered by changing the average of the rudder angles.

User input for changing the gate width we may be received e.g. by changing the position of a control element of the user interface UIF1. User input for changing the gate width w_{G} may be received e.g. by changing the position of a brake lever of the input device BRK1.

The ship velocity vs may be measured (step 1241). The rotation speed NRPM of the propeller PRO1 may be measured (step 1242).

The pitch angle α_{P} may be adjusted according to the rudder angles θ₁,θ₂, according to ship velocity vₛ, according to the rotation speed NRPM, and according to the selected shaft power PSET, so as to keep the shaft power Pₛ equal to the selected target power PSET (step 1250).

The method may comprise checking whether user input for stopping the constant power operating mode is received (step 1260). Operation in the constant power operating mode MODE2 may be stopped, in an instance where the user input for stopping operation in the constant power operating mode is received. Operation the variable power operating mode MODE1 may be started, respectively.

Changing the position of a control element of the power adjusting device PAU1 may be used as a command for changing the shaft power Pₛ, and also as a command for stopping operation in the constant power operating mode MODE2.

A predetermined target shaft power P_{sET} may be associated with the constant power operating mode MODE2. The control system may automatically change the shaft power to a default value P_{sET} before starting operation in the constant power operating mode MODE2.

A target shaft power P_{sET} for the constant power operating mode MODE2 may also be selected by using the user interface UIF1. The target shaft power P_{sET} may be selected e.g. by changing the position of a control element of the power adjusting device PAU1 of the user interface UIF1. The target shaft power P_{sET} may be e.g. in the range of 10% to 70% of the maximum nominal shaft power P_{MAX}.

Operation in the constant power mode MODE2 may be started based on user input in step 1650. The user input may be received e.g. via a control element of the user interface UIF1.

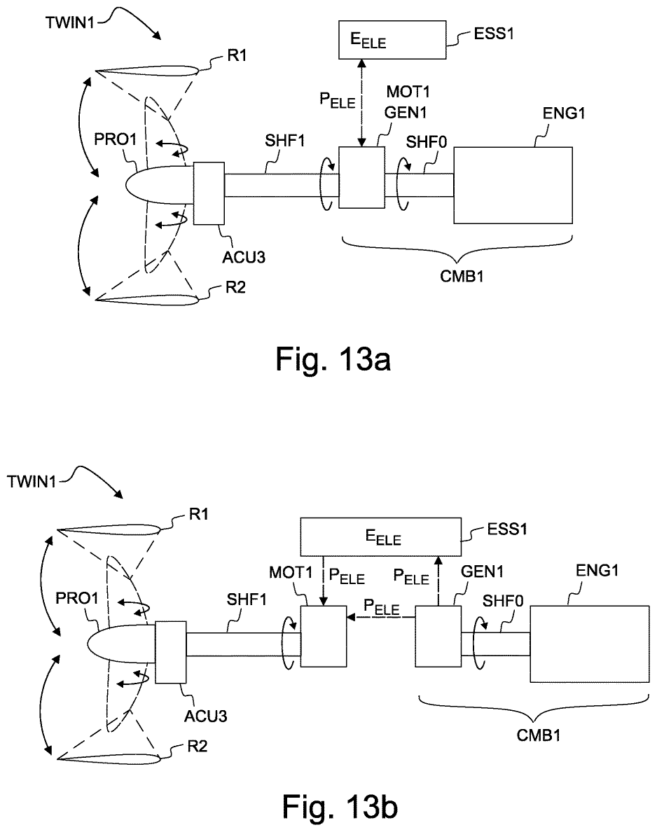

FIG. 13a shows, by way of example, a propulsion system TWIN1, which comprises a combination CMB1 of an engine ENG1 and an electric motor MOT1. The propeller PRO1 and the propeller shaft SHF1 may be rotated by using the combination CMB1 of the engine ENG1 and the electric motor MOT1. The shaft power Pₛ may be produced by the combination CMB1. The propulsion system TWIN1 comprising the combination CMB1 may also be called e.g. as a hybrid propulsion system.

The propulsion system TWIN1 may comprise an energy storage ESS1 for storing energy E_{ENE}. The energy storage ESS1 may comprise e.g. a battery. The energy storage ESS1 may provide electric power PELE for the electric motor MOT1. The electric motor MOT1 may convert the electrical power P_{ELE} into mechanical power of the propeller shaft SRF1. The engine ENG1 and the electric motor MOT1 may be arranged to rotate the propeller shaft SRF1 together. The electric motor MOT1 may provide auxiliary power for rotating the propeller shaft SRF1, together with the engine ENG1. The engine ENG1 may provide at least a part of the shaft power Pₛ and/or the electric motor MOT1 may provide at least a part of the shaft power Pₛ.

The combination CMB1 of the engine ENG1 and the electric motor MOT1 may have one or more optimum operating points. It may be advantageous to keep the shaft power Pₛ substantially constant near an optimum operating point of the combination CMB1. The optimum operating point means an optimum set of operating parameters. The operating parameters may include e.g. the shaft power Pₛ, the rotation speed N_{RPM}, and the electric power P_{ELE} of the electric motor MOT1.

The propulsion system TWIN1 may comprise a combination CMB1 of the engine ENG1 and a generator GEN1. In particular, the electric motor MOT1 may also be used as a generator GEN1. The propeller shaft SHF1 may be rotated by using a combination CMB1 of an engine ENG1 and the generator (MOT1, GEN1). The generator (MOT1, GEN1) may be arranged to convert at least a part of the mechanical power of the engine ENG1 into electric power P_{ELE}. The energy storage ESS1 may receive electric power P_{ELE} from the generator (MOT1, GEN1) and/or the energy storage ESS1 may provide electric power P_{ELE} for the electric motor (MOT1, GEN1). The generator GEN1 may be used as the electric motor MOT1, which may receive electrical power P_{ELE} from the electrical energy storage ESS1, and which may provide at least a part of the shaft power Pₛ for rotating the propeller PRO1 and the shaft SHF1.

The combination CMB1 of the engine ENG1 and the generator (MOT1, GEN1) may have one or more optimum operating points. It may be advantageous to keep the shaft power Pₛ substantially constant near an optimum operating point of the combination CMB1. The operating parameters may include e.g. the shaft power Pₛ, the rotation speed NRPM, and the electric power P_{ELE} of the generator (MOT1, GEN1)

The motor (MOT1, GEN1) may be coupled to the engine ENG1 e.g. by a coupling shaft SHF0, or by a coupling shaft portion SHF0. A portion of the propeller shaft SHF1 may be used as the coupling shaft portion SHF0.

The propulsion system TWIN1 may optionally comprise a (first) gearbox for reducing the rotation speed of the propeller shaft SRF1, so that the rotation speed of the propeller shaft SRF1 may be lower than the rotation speed of the engine ENG1. The propeller shaft SRF1 and the engine ENG1 may be coupled to the gearbox. The engine ENG1 may be coupled to the gearbox e.g. by the coupling shaft SHF0.

The propulsion system TWIN1 may optionally comprise a (second) gearbox for providing a suitable rotation speed for the motor (MOT1, GEN1), so that the rotation speed of the motor (MOT1, GEN1) may be e.g. higher than the rotation speed of the engine ENG1. The gearbox may be coupled to the engine ENG1 e.g. by the coupling shaft SHF0 or by the coupling shaft portion SHF0.

FIG. 13b shows, by way of example, a propulsion system which comprises a combination CMB1 of an engine ENG1, a generator GEN1, and an electric motor MOT1. The engine ENG1 may rotate the generator GEN1 by using a coupling shaft SHF0. The generator GEN1 may convert mechanical power of the engine into electric power P_{ELE}. The propeller shaft SHF1 and the propeller PRO1 may be rotated by using a separate electric motor MOT1. The electric motor MOT1 may convert electric power P_{ELE} into mechanical power of the propeller shaft SHF1. The electric motor MOT1 may receive electric power P_{ELE} directly from the generator GEN1 and/or via an energy storage ESS1. Electric energy E_{ELE} provided by the generator GEN1 may be temporarily stored in the energy storage ESS1. Electric energy E_{ELE} stored in the energy storage ESS1 may be used for rotating the electric motor MOT1. When using energy received from the energy storage ESS1, the maximum power, which may be provided by the electric motor MOT1 may be e.g. in the range of 10% to 200% of the maximum power of the engine ENG1. When using electric power PELE directly from the generator GEN1, the maximum power, which may be provided by the electric motor MOT1 may be e.g. in the range of 10% to 90% of the maximum power of the engine ENG1.

The combination CMB1 of the engine ENG1 and the generator GEN1 may have one or more optimum operating points. The electric motor MOT1 may have one or more optimum operating points. It may be advantageous to keep the shaft power Pₛ substantially constant near an optimum operating point of the electric motor MOT1 and/or near an optimum operating point of the combination CMB1. The optimum point means an optimum set of operating parameters. The operating parameters of the electric motor MOT1 may include e.g. the shaft power Pₛ, the rotation speed N_{RPM}, and the electric power P_{ELE} of the motor MOT1.

The present method comprises changing the velocity vs of the ship SHIP1 by changing the gate width w_{G}, and keeping the shaft power Pₛ substantially constant by changing the pitch angle α_{P}. The shaft power Pₛ may be kept substantially constant e.g. in one or more of the following situations:
The shaft power Pₛ is provided only by a single internal combustion engine ENG1.
The shaft power Pₛ is provided only by one or more internal combustion engines ENG1.
The shaft power Pₛ is provided by using a combination of a generator GEN1 and a single internal combustion engine ENG1. The generator GEN1 may also be used as an electric motor.
The shaft power Pₛ is provided by using a combination of a generator GEN1 and one or more internal combustion engines ENG1. The generator GEN1 may also be used as an electric motor.
The shaft power Ps is provided only by an electric motor MOT1, which is driven by using electric power P_{ELE}, which is generated in real time by using a combination of a generator GEN1 and one or more internal combustion engines ENG1.
The shaft power Pₛ is provided only by an electric motor MOT1, which is driven by using electric power P_{ELE} received from an energy storage ESS1, wherein the energy storage ESS1 is charged by using a combination of a generator GEN1 and one or more internal combustion engines ENG1.

The present method comprises changing the velocity vs of the ship SHIP1 by changing the gate width w_{G}, and keeping the shaft power Pₛ substantially constant by changing the pitch angle α_{P}. The shaft power Pₛ may be kept substantially constant e.g. in one or more of the following situations:
The engine ENG1 is an internal combustion engine, wherein at least a part of the shaft power Pₛ is produced by the engine ENG1. The shaft power Pₛ may be produced in real time by the engine ENG1.
The shaft power Pₛ is produced by a combination CMB1 of an electric motor MOT1 and at least one internal combustion engine ENG1. The shaft power Pₛ may be produced in real time by the combination CMB1.
The shaft power Pₛ is produced only by one or more internal combustion engines ENG1. The shaft power Ps may be produced in real time by the one or more internal combustion engines ENG1.
The shaft power Pₛ is produced only by a single internal combustion engine ENG1. The shaft power Ps may be produced in real time by the single internal combustion engine ENG1.

The shaft power Pₛ is the power, which is coupled from the propeller shaft SHF1 to the propeller PRO1, which is needed for rotating the propeller PRO1, and which is used for rotating the propeller PRO1. The shaft power Ps is coupled from the propeller shaft SHF1 to the propeller PRO1 in real time.

### LIST OF REFERENCE SYMBOLS

θ₁ Rudder angle of left rudder
θ₂ Rudder angle of right rudder
φ_{G} Braking angle,θ₁−θ₂
α_{P} Pitch angle
Δα Change of pitch angle
δₛ Steering angle, angular position of steering input device
ACU1 Actuator of left rudder
ACU2 Actuator of right rudder
ACU3 Actuator for changing pitch angle
ARM1 connecting portion of first rudder
ARM2 connecting portion of second rudder
AX0 Axis of propeller shaft
AX1 Turning axis of left rudder
AX2 Tuning axis of right rudder
BERTH1 Berth
BLAD1 Propeller blade
BRIDGE1 Navigation bridge, control room
BRK1 Input device for adjusting braking effect
CMB1 Combination of an engine and a generator
CNT1 Control unit
CSYS1 Control system
D_{PRO} Diameter of propeller
ENG1 Engine
E_{ELE} Electric energy
ESS1 Energy storage
FLW1 Water flow, streamline
FLW2 Water flow, streamline
fₚ Pitch control function
F_{T} Transverse force generated by the propulsion system
GEN1 Generator
GPOS Position of braking input device
HELM1 Steering input device
HUL1 ship hull
k_{G} Ratio of gate width to normal gate width
k_{P} Ratio of target power to maximum nominal shaft power
LE1 Leading edge of left rudder
LE2 Leading edge of right rudder
L_{SHIP} Length of ship
MEM1 Data memory
MEM2 Data memory
MODE1 Variable power operating mode
MODE2 Constant power operating mode
MOT1 Electric motor
M_{P} Propeller torque
N_{RPM} Rotation speed of propeller
P₁ First power value
P_{ELE} Electric power
PATH1 Path of ship
PATH2 Path of ship
PATH3 Path of ship
PAU1 Input device for adjusting power
P_{MAX} Maximum nominal shaft power
RB1 Blade of left rudder
RB2 Blade of right rudder
PORT1 Port
POS Waypoint
PRO1 Propeller
PROG1 Computer program code
Pₛ Shaft power
P_{sET} Target value of power
R1 Left rudder
R2 Right rudder
REG1 Region of a path
REG2 Region of a path
REG3 Region of a path
ROCK1 Obstacle
ROCK2 Obstacle
S_{BRK} Signal for adjusting braking effect
SEA1 Water, sea
NSEN1 Rotation speed sensor
S_{HELM} Signal indicative of steering direction
SHF1 Propeller shaft
SHF0 Coupling shaft
SHF11 Steering shaft of left rudder
SHF12 Steering shaft of right rudder
SHIP1 Ship
SIGN1 Navigation mark
SIGN2 Navigation mark
S_{NRPM} Signal indicative of rotation speed
S_{PITCH} Signal indicative of pitch angle
S_{PSET} Signal indicative of target power
S_{R1} Signal for controlling angular position of left rudder
S_{R2} Signal for controlling angular position of right rudder
SRF1 Surface of water, surface of sea
S_{VEL} Signal indicative of ship velocity
SX Longitudinal direction
SY Transverse direction
SZ Vertical direction
t Time
TE1 Trailing edge of left rudder
TE2 Trailing edge of right rudder
TWIN1 Propulsion system
UIF1 User interface
v₁ First velocity value
v₂ Second velocity value
vₛ Velocity of the ship
ωₛ Angular speed of the ship
VSEN1 Velocity sensor
w₀ Reference gate width
w_{G} Gate width
w_{AX12} Distance between rudder axes

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended claims.

1-19. (canceled)

20. A propulsion system (TWIN1) for moving a ship (SHIP1), the system (TWIN1) comprising:
a controllable pitch propeller (PRO1) driven by an engine (ENG1) and/or by an electric motor (MOT1),
a left rudder (R1),
a right rudder (R2), and
a control system (CSYS1),
wherein the left rudder (R1) has a first turning axis (AX1) and a first trailing edge (TE1), wherein the right rudder (R2) has a second turning axis (AX2) and a second trailing edge (TE2), wherein a distance (w_{G}) between the trailing edges (TE1,TE2) is adjustable by changing the difference (θ₁−θ₂) between a rudder angle (θ₁) of the left rudder (R1) and a rudder angle (θ₂) of the right rudder (R2),
wherein the propulsion system (TWIN1) has a first operating mode (MODE1), where changing the velocity (vₛ) of the ship (SHIP1) comprises changing the shaft power (Pₛ) of the propeller (PRO1),
wherein the propulsion system (TWIN1) has a second operating mode (MODE2), where the control system (SYS1) is arranged to change the velocity (vₛ) of the ship (SHIP1) by changing the difference (θ₁−θ₂) between the rudder angle (θ₁) of the left rudder (R1) and the rudder angle (θ₂) of the right rudder (R2), wherein the control system (SYS1) is arranged to change the pitch angle (α_{P}) of the propeller (PRO1) such that the shaft power (Pₛ) is kept substantially equal to a first power value (P1) in a situation where the velocity (vₛ) of the ship (SHIP1) is changed by changing the difference (θ₁−θ₂) between the rudder angles (θ₁,θ₂).

21. The propulsion system (TWIN1) of claim 20, wherein the control system (SYS1) is arranged to change the pitch angle (α_{P}) of the propeller (PRO1) such that the absolute value of the difference (P₁−Pₛ) between the shaft power (Pₛ) and the first power value (P₁) remains smaller than 10% of the first power value (P₁) in a situation where the velocity (vₛ) of the ship (SHIP1) is changed from a first higher velocity value (v₁) to a second lower velocity value (V₂) by changing the difference (θ₁−θ₂) between the rudder angles (θ1,θ2), wherein the ratio of the lower second velocity value (v₂) to the first higher velocity value (v₁) is in the range of 30% to 70%.

22. The propulsion system (TWIN1) of claim 20, wherein the control system (SYS1) is arranged to change the pitch angle (α_{P}) of the propeller (PRO1) such that the absolute value of the difference (P₁−Pₛ) between the shaft power (Pₛ) and the first power value (P₁) remains smaller than 10% of the first power value (P₁) in a situation where the velocity (vₛ) of the ship (SHIP1) is changed from a lower velocity value (v₂) to a higher velocity value (v₁) by changing the difference (θ₁−θ₂) between the rudder angles (θ₁,θ₂), wherein the ratio of the lower velocity value (v₂) to the higher velocity value (v₁) is in the range of 30% to 70%.

23. The propulsion system (TWIN1) according to claim 20, further comprising a velocity sensor (VSEN1) for measuring the velocity (vₛ) of the ship (SHIP1), wherein the control system (SYS1) is arranged to control the pitch angle (α_{P}) of the propeller (PRO1) based on the rudder angles (θ₁,θ₂) and based on the measured velocity (vₛ) of the ship (SHIP1), such that the shaft power (Pₛ) is kept substantially equal to a first power value (P₁) in a situation where the velocity (vₛ) of the ship (SHIP1) is changed by changing the difference (θ₁−θ₂) between the rudder angles (θ₁,θ₂).

24. The propulsion system (TWIN1) according to claim 20, wherein the control system (SYS1) is arranged to stop operation in the constant power operating mode (MODE2) in a situation where user input for changing the shaft power (Pₛ) is received via a user interface (UIF1).

25. The propulsion system (TWIN1) according to claim 20, wherein the rudders (R1, R2) and the propeller (PRO1) are dimensioned according to a maximum shaft power (P_{MAX}), wherein the rudders (R1, R2) and the propeller (PRO1) are dimensioned such that the propulsion system (TWIN1) is able to operate in the constant power operating mode (MODE2) at least in a situation where the first power value (P₁) is in the range of 10% to 30% of the maximum shaft power (P_{MAX}).

26. The propulsion system (TWIN1) according to claim 20, further comprising a reciprocating internal combustion engine (ENG1).

27. A ship (SHIP1), comprising the propulsion system (TWIN1) according to claim 20.

28. A method for controlling propulsion of a ship (SHIP1), the ship (SHIP1) comprising a propulsion system (TWIN1), the propulsion system (TWIN1) comprising:
an engine (ENG1),
a controllable pitch propeller (PRO1) driven by the engine (ENG1) and/or by an electric motor (MOT1),
a left rudder (R1),
a right rudder (R2), and
a control system (CSYS1),
wherein the left rudder (R1) has a first turning axis (AX1) and a first trailing edge (TE1), wherein the right rudder (R2) has a second turning axis (AX2) and a second trailing edge (TE2), wherein a distance (w_{G}) between the trailing edges (TE1, TE2) is adjustable by changing the difference (θ₁−θ₂) between a rudder angle (θ₁) of the left rudder (R1) and a rudder angle (θ₂) of the right rudder (R2),
wherein the propulsion system (TWIN1) has a first variable power operating mode (MODE1), where changing the velocity (vₛ) of the ship (SHIP1) comprises changing the shaft power (Pₛ) of the propeller (PRO1),
wherein the propulsion system (TWIN1) has a second constant power operating mode (MODE2), where the control system (SYS1) is arranged to change the velocity (vₛ) of the ship (SHIP1) by changing the difference (θ₁−θ₂) between the rudder angle (θ₁) of the left rudder (R1) and the rudder angle (θ₂) of the right rudder (R2), the method comprising:
changing the velocity (vₛ) of the ship (SHIP1) by changing the difference (θ₁−θ₂) between the rudder angles (θ₁,θ₂), and
changing the pitch angle (α_{P}) of the propeller (PRO1) such that the shaft power (Pₛ) is kept substantially equal to a first power value (P₁) in a situation where the velocity (vₛ) of the ship (SHIP1) is changed by changing the difference (θ₁−θ₂) between the rudder angles (θ₁,θ₂).

29. The method of claim 28, further comprising changing the pitch angle (α_{P}) of the propeller (PRO1) such that the absolute value of the difference (P₁−Pₛ) between the shaft power (Pₛ) and the first power value (P₁) remains smaller than 10% of the first power value (P₁) in a situation where the velocity (vₛ) of the ship (SHIP1) is changed from a first higher velocity value (V₁) to a second lower velocity value (v₂) by changing the difference (θ₁−θ₂) between the rudder angles (θ₁,θ₂), wherein the ratio of the lower second velocity value (v₂) to the first higher velocity value (v₁) is in the range of 30% to 70%.

30. The method of claim 28, further comprising changing the pitch angle (α_{P}) of the propeller (PRO1) such that the absolute value of the difference (P₁−Pₛ) between the shaft power (Pₛ) and the first power value (P₁) remains smaller than 10% of the first power value (P₁) in a situation where the velocity (vₛ) of the ship (SHIP1) is changed from a lower velocity value (v₂) to a higher velocity value (v₁) by changing the difference (θ₁−θ₂) between the rudder angles (θ₁,θ₂), wherein the ratio of the lower velocity value (V₂) to the higher velocity value (V₁) is in the range of 30% to 70%.

31. The method according to claim 28, further comprising measuring the velocity (vₛ) of the ship (SHIP1), and controlling the pitch angle (α_{P}) of the propeller (PRO1) based on the rudder angles (θ₁,θ₂) and based on the velocity (vₛ) of the ship (SHIP1) such that the shaft power (Pₛ) is kept substantially equal to a first power value (P₁) in a situation where the velocity (vₛ) of the ship (SHIP1) is changed by changing the difference (θ₁−θ₂) between the rudder angles (θ₁,θ₂).

32. The method according to claim 28, further comprising stopping operation in the constant power operating mode (MODE2) in a situation where user input for changing the shaft power (Pₛ) is received via a user interface (UIF1).

33. The method according to claim 28, wherein the first power value (P₁) is in the range of 10% to 30% of the maximum shaft power (P_{MAX}).

34. The method according to claim 28, wherein the engine (ENG1) is a reciprocating internal combustion engine, wherein the fuel of the engine is ammonia, gaseous fuel, or liquified gas, or a combination which comprises ammonia, gaseous fuel, and/or liquified combustible gas.

35. The method according to claim 28, wherein the engine (ENG1) is an internal combustion engine, wherein at least a part of the shaft power (Pₛ) is produced by the engine (ENG1).

36. The method according to claim 28, wherein the shaft power (Pₛ) is produced by a combination (CMB1) of the electric motor (MOT1) and at least one internal combustion engine (ENG1).

37. The method according to claim 28, wherein the shaft power (Pₛ) is produced only by one or more internal combustion engines (ENG1).

38. The method according to claim 28, wherein the shaft power (Pₛ) is produced only by a single internal combustion engine (ENG1).
